(19) United States
(12) Patent Application Publication
(10) Pub. No.: US 2010/0250734 A1
(43) Pub. Date: Sep. 30, 2010

(54) SERVER REASSIGNMENT SUPPORT SYSTEM AND SERVER REASSIGNMENT SUPPORT METHOD

(75) Inventor: Yasuhiro Ajiro, Tokyo (JP)

Correspondence Address: FOLEY AND LARDNER LLP;SUITE 500, 3000 K STREET NW, WASHINGTON, DC, 20007, US

(73) Assignee: NEC CORPORATION, Tokyo (JP)

(21) Appl. No.: 12/678,433

(22) PCT Filed: Jul. 16, 2008
(86) PCT No.: PCT/JP2008/062792

§ 371 Date: May 25, 2010

(30) Foreign Application Priority Data
Sep. 18, 2007 (JP) 2007-240964

(51) Int. Cl. G06F 15/173

(52) U.S. Cl. 709/224

(57) ABSTRACT

A server reassignment support system has a storage device, a deallocated state estimation module and an allocation plan generation module. Stored in the storage device are an operation data indicating operation status of a plurality of physical servers and a plurality of virtual servers and a capacity data indicating resource capacity of each of the plurality of physical servers. The deallocated state estimation module refers to the operation data and the capacity data to extract an overloaded server from the plurality of physical servers, load of the overloaded server exceeding a threshold value depending on the resource capacity. Further, the deallocated state estimation module estimates a state in which at least part of virtual servers allocated to the overloaded server is deallocated as a deallocated server among the plurality of virtual servers. The allocation plan generation module generates an allocation plan for the deallocated server based on the estimated state.

### TECHNICAL FIELD

The present invention relates to server reassignment. In particular, the present invention relates to a technique for supporting the server reassignment.

### BACKGROUND ART

According to the virtualization technology using virtualization software such as VMware and Xen, it is possible to make one physical server to operate as a plurality of virtual severs. As a result, it becomes easier to streamline a server operation according to the situation (refer to Japanese Patent Publication JP-2005-115653A and Japanese Patent Publication JP-2002-202959A, for example). It is also possible by using the virtualization technology to easily achieve server reassignment.

FIG. 1 conceptually shows an example of the server reassignment. As shown in FIG. 1, let us consider a case where a server operation is carried out with virtual servers VM1 to VM5 which run on physical servers M1 to M3. In the daytime when load is increased, the virtual servers VM1 and VM2 are built on the physical server M1, the virtual servers VM3 and VM4 are built on the physical server M2, and the virtual server VM5 is built on the physical server M3. On the other hand, in the nighttime when load is decreased, the virtual servers VM1, VM2 and VM4 are built on the physical server M1, the virtual servers VM3 and VM5 are built on the physical server M2, and thus the physical server M3 is not used. Since the number of servers used is reduced, operation management costs can be reduced.

As described in this example, the server reassignment means to change allocation of the virtual servers to the physical servers depending on the operation state. In a case where load as a whole is decreased, the number of physical servers may be reduced by changing the allocation of the virtual servers. On the other hand, in a case where load as a whole is increased and thus a physical server becomes an overloaded state, the overloaded state needs to be resolved by changing the allocation of the virtual servers. A physical server is added according to circumstances.

In the server reassignment, it is desirable not only to estimate the number of physical servers under the post-reassignment state but also to prepare a “server reassignment plan” that indicates “which virtual server is migrated to which physical server”. A fundamental condition that the server reassignment plan should meet is an inclusion relation between computer resources. That is to say, the sum of “resource usage” of virtual servers which are to be allocated to a certain physical server must not exceed “resource capacity” of the certain physical server. Here, the computer resources include a CPU, disk, memory and network.

Also, a plan with which the number of servers under the post-reassignment state becomes as small as possible is preferable from the viewpoint of the costs. When goods of various sizes are packed in bins with the same constant capacity, a problem of finding a minimum number of bins necessary for packing the set of goods is generally called a “Bin Packing Problem”. With regard to the Bin Packing Problem, it is well known that to find an optimum solution within a practical time is extremely difficult. A “First-Fit-Decrease (FFD) algorithm” is known as an approximate solution algorithm (refer to “Combinatorial Optimization: Theory and Algorithms”, written by B. Korte and J. Vygen, translated by Takao Asano et al., Springer-Verlag Tokyo, Nov. 3, 2005, pp. 466-472).

A load balancing technique with respect to a parallel computer is described in Japanese Patent Publication JP-H10-27167A. The parallel computer consists of a plurality of computers and executes a parallel program composed of a plurality of constitutive programs. When the plurality of constitutive programs are allocated to the plurality of computers, the load balancing is performed in consideration of the load applied to the computer by the constitutive program itself. More specifically, a history collecting program collects resource utilization of each constitutive program. Moreover, a scheduler refers to the current resource utilization of each computer and allocates a constitutive program with the larger resource utilization to a computer with the smaller current resource utilization. In other words, the scheduler allocates processing with a heavier load to a computer with a larger available capacity.

Japanese Patent Publication JP-2003-131909 describes a file management method in a computer network system in which a plurality of file servers are connected to a client computer. A comparison unit periodically refers to maximum-storage capacity data and currently-used capacity data of the respective file servers. Agent property updates data stored in a server state database with the data obtained by the comparison unit. When file movement occurs between the plurality of file servers, its result is described in a movement log. If the amount of usage in the plurality of file servers exceeds a limit capacity, the agent property moves data to a server having much available amount among the plurality of file servers.

### DISCLOSURE OF INVENTION

An object of the present invention is to provide a technique that can mechanically generate an appropriate server reassignment plan.

In a first aspect of the present invention, a server reassignment support system that supports reassignment of a plurality of virtual servers allocated to a plurality of physical servers. The server reassignment support system has a storage means, a deallocated state estimation means and an allocation plan generation means. An operation data indicating operation status of the plurality of physical servers and the plurality of virtual servers and a capacity data indicating resource capacity of each of the plurality of physical servers are stored in the storage means. The deallocated state estimation means refers to the operation data and the capacity data to extract an overloaded server from the plurality of physical servers, load of the overloaded server exceeding a threshold value depending on the resource capacity. Further, the deallocated state estimation means estimates a state in which at least part of virtual servers allocated to the overloaded server is deallocated as a deallocated server among the plurality of virtual servers. The allocation plan generation means generates an allocation plan for the above-mentioned deallocated server based on the estimated state estimated by the deallocated state estimation means.

In a second aspect of the present invention, a server reassignment support method for supporting, by using a computer, reassignment of a plurality of virtual servers allocated to a plurality of physical servers is provided. The server reassignment support method includes: (A) a step of reading an operation data indicating operation status of the plurality of physical servers and the plurality of virtual servers from a storage means; (B) a step of reading a capacity data indicating resource capacity of each of the plurality of physical servers from a storage means; (C) a step of extracting an overloaded server from the plurality of physical servers, load of the overloaded server exceeding a threshold value depending on the resource capacity, with reference to the operation data and the capacity data; (D) a step of estimating a state in which at least part of virtual servers allocated to the overloaded server is deallocated as a deallocated server among the plurality of virtual servers; and (E) a step of generating an allocation plan for the deallocated server based on the estimated state.

In a third aspect of the present invention, a server reassignment support program for supporting reassignment of a plurality of virtual servers allocated to a plurality of physical servers is provided. The server reassignment support program causes a computer to perform the processing including: (A) a step of reading an operation data indicating operation status of the plurality of physical servers and the plurality of virtual servers from a storage means; (B) a step of reading a capacity data indicating resource capacity of each of the plurality of physical servers from a storage means; (C) a step of extracting an overloaded server from the plurality of physical servers, load of the overloaded server exceeding a threshold value depending on the resource capacity, with reference to the operation data and the capacity data; (D) a step of estimating a state in which at least part of virtual servers allocated to the overloaded server is deallocated as a deallocated server among the plurality of virtual servers; and (E) a step of generating an allocation plan for the deallocated server based on the estimated state.

According to the present invention, it is possible to mechanically generate an appropriate server reassignment plan.

### BRIEF DESCRIPTION OF DRAWINGS

The above and other objects, advantages and features of the present invention will be more apparent from the following description of certain exemplary embodiments taken in conjunction with the accompanying drawings.

FIG. 1 is a conceptual diagram showing one example of server migration.

FIG. 2 is a conceptual diagram for explaining server allocation processing in an exemplary embodiment of the present invention.

FIG. 3 is a block diagram showing an example of allocation plan generation module that performs the server allocation processing in the exemplary embodiment of the present invention.

FIG. 4 is a flow chart showing an example of the server allocation processing in the exemplary embodiment of the present invention.

FIG. 5 is a conceptual diagram showing an example of the server allocation processing.

FIG. 6 is a block diagram schematically showing a server reassignment support system according to the exemplary embodiment of the present invention.

FIG. 7 is a conceptual diagram for explaining processing of generating a server reassignment plan in the exemplary embodiment of the present invention.

FIG. 8 is a table showing an operation data with regard to physical servers.

FIG. 9 is a table showing an operation data with regard to virtual servers.

FIG. 10 is a table showing a capacity data with regard to physical servers.

FIG. 11 is a block diagram showing a server reassignment support system according to a first exemplary embodiment.

FIG. 12 is a flow chart showing the processing of generating a server reassignment plan in the first exemplary embodiment.

FIG. 13 is a conceptual diagram showing an example of the processing of generating the server reassignment plan in the first exemplary embodiment.

FIG. 14 is a block diagram showing a server reassignment support system according to a second exemplary embodiment.

FIG. 15 is a flow chart showing the processing of generating a server reassignment plan in the second exemplary embodiment,

FIG. 16 is a conceptual diagram showing an example of the processing of generating the server reassignment plan in the second exemplary embodiment.

FIG. 17 is a block diagram showing a server reassignment support system according to a third exemplary embodiment.

FIG. 18 is a flow chart showing the processing of generating a server reassignment plan in the third exemplary embodiment.

FIG. 19 is a block diagram showing a configuration example of the server reassignment support system.

FIG. 20 is a block diagram schematically showing a modification example of the server reassignment support system.

FIG. 21 is a block diagram showing another configuration example of the server reassignment support system.

### DESCRIPTION OF EMBODIMENTS

A server reassignment technique according to an exemplary embodiment of the present invention will be described with reference to the attached drawings.

### 1. Server Allocation

### Allocation

The applicant has previously filed an application which relates to server migration (Japanese Patent Application No. 2007-43787: not published yet). The server migration is exemplified by “server consolidation” and “server reassignment”. The disclosure of Japanese Patent Application No. 2007-43787 is incorporated herein in its entirety by reference. Let us first explain an example of the technique described in Japanese Patent Application No. 2007-43787.

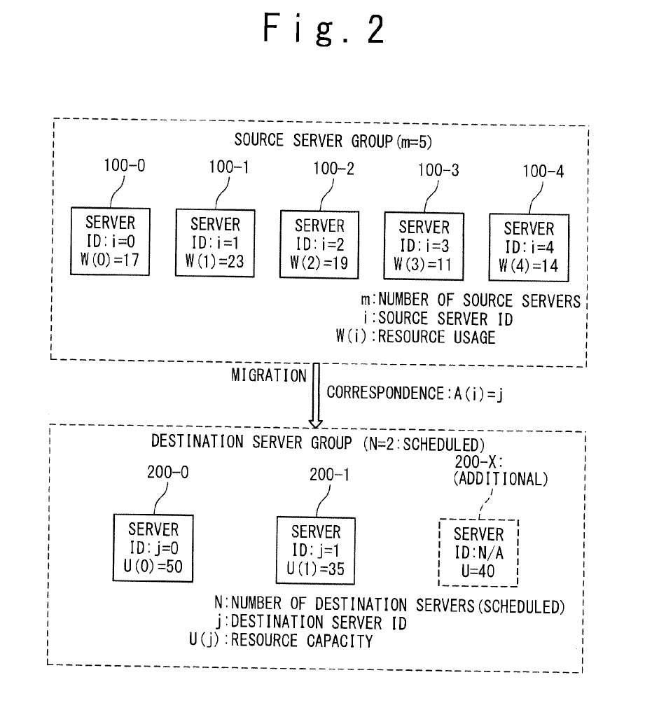

FIG. 2 conceptually shows the server migration. In the server migration, it is necessary to allocate a source server to any of destination servers. In FIG. 2, a source server group is constituted by m servers 100-0 to 100-(m−1). The m is an integer not less than 2. Let us consider a case where N servers 200-0 to 200-(N−1) are scheduled to be used as destinations of these source servers 100. The N is an integer not less than 1. For example, the m is 5 and the N is 2. Note that if the N destination servers 200 are not enough, an additional destination server 200-X different from them will be added. That is to say, the m source servers 100 are migrated to at least N destination servers 200.

Each server may be a real machine or may be a virtual machine achieved by the virtualization technology. Each server uses computer resource such as a CPU, a disk, a memory and a network. It is therefore possible to define “resource usage” with respect to each source server 100, where the resource usage means the amount of computer resource that has been used by the source server 100. On the other hand, it is possible to define “resource capacity” with respect to each destination server 200, where the resource capacity means the allowable amount of computer resource that is used by the destination server 200, i.e., the usable (available) amount of computer resource.

One example of the resource usage is CPU usage. The CPU usage is given by the product of “CPU relative performance value” and “CPU utilization”. For example, when a source server 100 is equipped with a CPU relative performance of “80” and has operated with a CPU utilization of up to “60%”, the resource usage of the source server 100 is calculated to be “48 (=80×0.60)”. The resource capacity of the destination server 200 can be defined in the same way. For example, when a destination server 200 equipped with a CPU relative performance of “120” is scheduled to be used and operated with a CPU utilization of up to “75%”, the resource capacity of the destination server 200 is calculated to be “90 (=120×0.75)”.

As shown in FIG. 2, an integer i (=0 to (m−1)) as an ID number is given to each of the source servers 100. The resource usage of the source server i is represented by W(i). In the example shown in FIG. 2, W(0)=17, W(1)=23, W(2)=19, W(3)=11 and W(4)=14. Similarly, an integer j (=0 to (N−1)) as an ID number is given to each of the destination servers 200. The resource capacity of the destination server j is represented by U(j). In the example shown in FIG. 2, U(0)=50 and U(1)=35. Note that the resource capacity U of the additional server 200-X is a default value of 40.

In advance of the server migration, it is necessary to prepare an “allocation plan” that indicates “to which destination server 200, each source server 100 is allocated”. In other words, it is necessary to determine a correspondence relationship (A(i)=j) between the ID number i and the ID number j. A fundamental condition that the allocation plan should meet is an inclusion relation between the above-mentioned computer resources. That is to say, the sum of resource usage W(i) of the source servers i which are to be allocated to a certain destination server j must not exceed the resource capacity U(j) of the certain destination server j. Moreover, an allocation plan with which the number of servers n (n is an integer not less than N) under the post-migration state becomes as small as possible is preferable from the viewpoint of the costs.

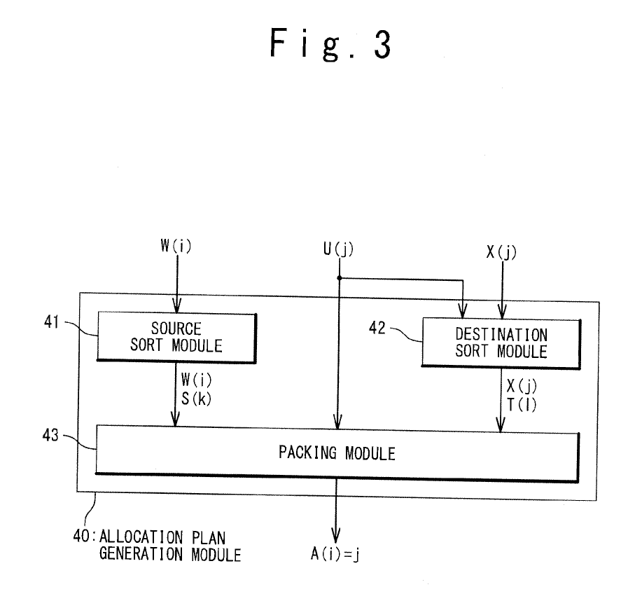

FIG. 3 shows an example of an allocation plan generation module 40 that determines the correspondence relationship A(i)=ⱼ, namely the allocation plan. Input to the allocation plan generation module 40 are the resource usage W(i) of respective source servers, the resource capacity U(j) and resource usage X(j) of respective destination servers. The resource usage X(j) of a certain destination server j is the sum of the resource usage W(i) of the source servers i which are allocated to the certain destination server j, and is also referred to as “allocated resource amount”. When no source server is yet allocated to a destination server j, the resource usage X(j) of the destination server j is 0. The allocation plan generation module 40 determines a preferable allocation relationship A(i)=j based on the resource usage W(i), the resource capacity U(j) and the resource usage X(j).

In FIG. 3, the allocation plan generation module 40 has a source sort module 41, a destination sort module 42 and a packing module 43. A function of the allocation plan generation module 40, namely, server allocation processing will be described below in detail.

The source sort module 41 receives the resource usage W(i) of the source servers. Then, the source sort module 41 sorts the source servers in descending order of the resource usage W(i). Moreover, the source sort module 41 stores the sort result in an array S. Each element of the array S is represented by S(k) (k=0 to m−1). In this case, an element S(0) indicates the ID number i of the source server whose resource usage W(i) is the maximum, while an element S(m−1) indicates the ID number i of the source server whose resource usage W(i) is the minimum. In the present example, S=[1, 2, 0, 4, 3], W(S(0))=23, W(S(1))=19, W(S(2))=17, W(S(3))=14, and W(S(4))=11. As described later, the array S=[1, 2, 0, 4, 3] gives the order of the allocation processing.

On the other hand, the destination sort module 42 receives the resource capacity U(j) and the resource usage X(j) of the destination servers. Then, the destination sort module 42 calculates remaining amount (U(j)−X(j)) of the resource of the respective destination servers and sorts the destination servers in ascending order of the remaining amount. Moreover, the destination sort module 42 stores the sort result in an array T. Each element of the array T is represented by T(l) (l=0 to N−1). In this case, an element T(0) indicates the ID number j of the destination server whose resource capacity U(j) is the minimum, while an element T(N-1) indicates the ID number j of the destination server whose resource capacity U(j) is the maximum. Currently, the respective resource usage X(j) are 0. In this case, T=[1, 0], U(T(0))=35, and U(T(1))=50.

The packing module 43 performs “packing processing” by the use of the resource usage W(i), the array S, the resource capacity U(j), U, the resource usage X(j) and the array T. In the packing processing, the packing module 43 allocates each source server i to any destination server j. As a result, the allocation relationship (A(i)=j), the required number n of the destination servers and the final resource usage X(j) are determined.

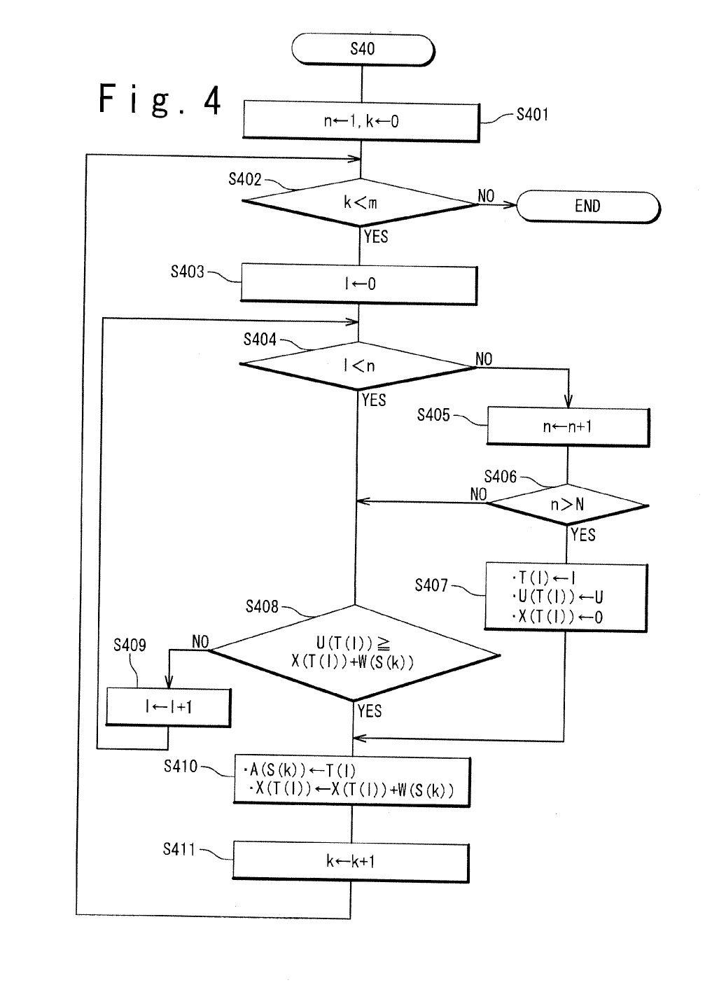

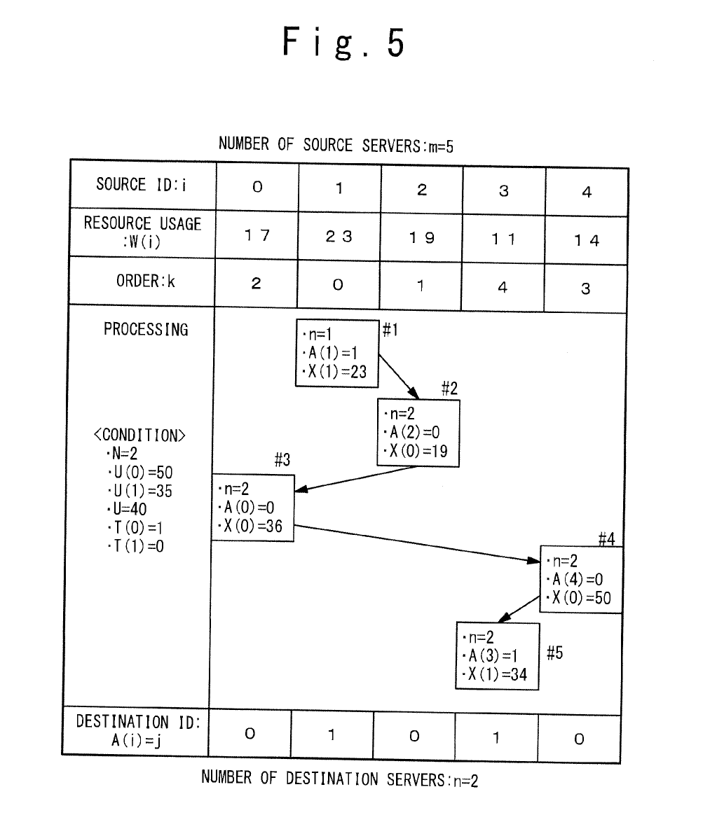

FIG. 4 is a flow chart showing the server allocation processing (Step S40). FIG. 5 is a conceptual diagram showing an example of generation of the allocation plan. As shown in FIG. 5, the parameter k indicating the element of the array S represents the order of the magnitude of the resource usage W(i), and k=0, 1, 2, 3, 4 correspond to i=1, 2, 0, 4, 3, respectively.

First, the parameter n indicating the required number of servers is initialized to be 1. Also, the above-mentioned parameter k is initialized to be 0 (Step S401). The parameter k is used as a counter for loop processing described below, and is increased from an initial value 0 by one at a time. In a single loop processing, a source server i of the ID number given by S(k) is allocated to any one of the destination servers J. When the allocation processing for all the source servers is completed (Step S402; No), the loop processing ends and Step S40 is completed.

Since the parameter k is increased by one at a time from the initial value 0, an object of the allocation processing changes in the order of the ID number i=1, 2, 0, 4 and 3. That is to say, the source servers i are selected one-by-one as the object of the allocation processing in descending order of the resource usage W(i). By carrying out the allocation processing in descending order of the resource usage W(i), it is possible to allocate all the source servers to a smaller number of the destination servers. This is based on the heuristics in the Bin Packing Problem; first arrange the larger one and then arrange the smaller one in empty space, which results in a smaller number of bins.

(First Loop Processing: k=0, i=S(0)=1)

First, the destination server (l=0; j=T (0)=1) is selected (Step S403). At this time, the l is smaller than the n (Step S404; Yes), and the processing proceeds to Step S408.

At Step S408, the resource capacity U(j) is compared with the sum of the resource usage X(j) and the resource usage W(i). This means a comparison between the resource usage W(i) of the selected source server i and a remaining amount (=U(j)−X(j)) of the resource capacity of the selected destination server j. Hereafter, the resource usage W(i) of the comparison object may be referred to as “comparison-object usage W(i)”. In the current loop processing, the comparison-object usage (W(1)=23) is compared with the remaining amount (U(1)−X(1)=35).

Since the comparison-object usage is not more than the remaining amount (Step S408; Yes), Step S410 is executed. At Step S410, the selected source server (i=1) is allocated to the selected destination server (j=1). That is, an allocation relationship A(1)=1 is determined. At the same time, the comparison-object usage W(1) is added to the resource usage X(1). In FIG. 5, a box to which a symbol # is given shows a result of each loop processing. The result of the current loop processing is shown in a box to which a symbol #1 is given. After that, the parameter k is incremented and the next source server S(1) is selected (Step S411).

(Second Loop Processing: k=1, i=S(1)=2)

The destination server (l=0; j=T(0)=1) is selected again (Step S403). In the comparison (Step S408), the comparison-object usage (W(2)=19) is more than the remaining amount (U(1)−X(1)=35−23) (Step S408; No). In this case, the parameter l is increased by one (Step S409). That is, the next destination server (j=T(l)=0) is selected. In this manner, the parameter l is initialized each time the loop processing is started and is increased by one at a time as necessary. As a result, the object of the comparison processing changes in the order from the destination server (j=T(0)=1) to the destination server (j=T(1)=0). This means that the destination server j as the object of the comparison processing is selected from the N destination servers in ascending order of the resource capacity of the remaining amount.

Since the new destination server (l=1; j=0) is selected, 1 is added to the required number n (Step S404; No, Step S405). As a result, the required number n becomes 2. At this time, the two destination servers that are scheduled to be used are still sufficient (Step S406; No). Therefore, the processing proceeds to Step S408.

In the comparison processing (Step S408), the comparison-object usage (W(2)=19) is not more than the remaining amount (U(0)−X(0)=50) (Step S408; Yes). Therefore, the source server (i=2) is allocated to the destination server (j=0) (Step S410). That is, an allocation relationship A(2)=0 is determined, and the comparison-object usage W (2) is added to the resource usage X(0) (refer to #2 in FIG. 5). Then, the next source server S(2) is selected (Step S411).

(Third Loop Processing: k=2, i=S(2)=0)

The destination server (l=0; j=T(0)=1) is selected again (Step S403). In the comparison processing (Step S408), the comparison-object usage (W(0)=17) is more than the remaining amount (U(1)−X(1)=35−23) (Step S408; No). Therefore, the next destination server (l=1; j=T(1)=0) is selected (Step S409). Since the required number n is already 2 (Step S404; Yes), the processing proceeds to Step S408.

In the comparison processing (Step S408), the comparison-object usage (W(0)=17) is not more than the remaining amount (U(0)−X(0)=50−19) (Step S408; Yes). Therefore, the source server (i=0) is allocated to the destination server (j=0) (Step S410). That is, an allocation relationship A(0)=0 is determined, and the comparison-object usage W(0) is added to the resource usage X(9) (refer to #3 in FIG. 5). Then, the next source server S(3) is selected (Step S411).

(Fourth Loop Processing: k=3, i=S(3)=4)

The processing proceeds in a similar way to the above-mentioned third loop processing, and the source server (i=4) is allocated to the destination server (j=0) (Step S410). That is, an allocation relationship A(4)=0 is determined, and the resource usage X(0) becomes 50 (=19+17+14) (refer to #4 in FIG. 5). Then, the next source server S(4) is selected (Step S411).

(Fifth Loop Processing: k=4, i=S(4)=3)

The destination server (l=0; j=T(0)=1) is selected again (Step S403). In the comparison processing (Step S408), the comparison-object usage (W(3)=11) is not more than the remaining amount (U(1)−X(1)=35−23) (Step S408; Yes). Therefore, the source server (i=3) is allocated to the destination server (j=1) (Step S410). That is, an allocation relationship A(3)=1 is determined, and the comparison-object usage W(3) is added to the resource usage X(1) (refer to #5 in FIG. 5).

After that, the parameter k becomes 5 at Step S411. This means that the allocation processing is completed with regard to all of the source servers (Step S402; No). Therefore, the loop processing is stopped and the server allocation processing (Step S40) is completed. Consequently, the allocation relationship “A(0)=0, A(1)=1, A(2)=0, A(3)=1, A(4)=0” is determined, as shown in FIG. 5. The required number n of the destination servers is 2. The resource usage scheduled to be used in the respective destination server are X(0)=50 and X(1)=34.

Note that in some cases, the comparison-object usage W(i) of a source server i may be more than the remaining amount of every one of the two destination servers which are scheduled to be used. That is, there may be a case where the required number n becomes 3 and excesses the scheduled number N (=2) (Step S406; Yes). In that case, a destination server 200-X having the default resource capacity U is added as a destination server (j=3) (Step S407). The resource capacity U(3) of the destination server (j=3) is set to the default value U. Also, the resource usage X(3) is set to an initial value 0. After that, the processing proceeds to Step S410, and the source server i is allocated to the added destination server (j=3).

As described above, it is possible to mechanically generate the allocation plan to servers whose number is within an appropriate range. It is possible to mechanically generate a suitable allocation plan, even in a case where the resource capacity U(j) of the destination servers are different from each other. As a result, burden on a system designer is reduced and a time required to accomplish the server migration is reduced.

It should be noted that the method shown in FIG. 3 to FIG. 5 is just an example of the technique disclosed in Japanese Patent Application No. 2007-43787. The allocation plan generation module 40 may provide any function described in Japanese Patent Application No. 2007-43787. For example, the allocation plan generation module 40 may not include the destination sort module 42. In this case, the array T(1) is not used, and the parameter j instead of the parameter l is initialized each time the loop processing is started and is increased by one at a time as necessary. That is, the destination server as the object of the comparison processing is selected in the order of the ID number j.

It should also be noted that, as described in Japanese Patent Application No. 2007-43787, the required number n may be suppressed by the method shown in FIG. 3 to FIG. 5. That is, improvement of allocation efficiency is expected by using the array T and selecting the object of the comparison processing in ascending order of the remaining amount of the resource capacity U(j). According to the method shown in FIG. 3 to FIG. 5, the source server with the larger resource usage W(i) is allocated to the destination server with the smaller remaining amount of the resource capacity U(j). This corresponds to a procedure in which processing with the heavier load is allocated to a computer with the smaller available capacity, which is opposite to the procedure described in heretofore-known Japanese Patent Publication JP-2002-202959

### 2. Server Reassignment

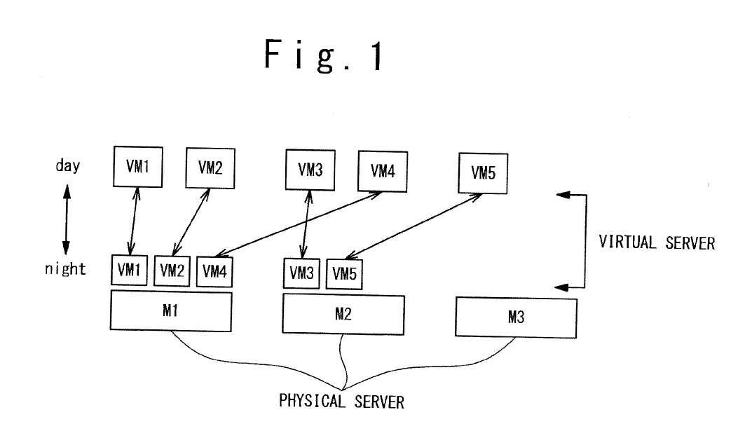

Next, let us consider the server reassignment as shown in FIG. 1. In this case, the virtual servers VM1 to VM5 correspond to the source servers, and the physical servers M1 to M3 correspond to the destination servers. When load imposed on a certain physical server exceeds a threshold value, namely, when the certain physical server becomes an overloaded state, the server reassignment is required. More specifically, the allocation of the virtual servers needs to be changed in order to resolve the overloaded state.

The technique described in the First Section (1. server allocation) may be applied in order to change the allocation of the virtual servers. In this case, a preferable allocation relationship A(i)=j that meets the inclusion relation between the computer resources is determined in consideration of the resource usage W(i) of the virtual servers and the resource capacity U(j) of the physical servers, as described above. Consequently, the overloaded state will be resolved. However, in the case of the technique described in the First Section, the current allocation state of the virtual servers is not taken into consideration. That is, the allocation relationship A(i)=j between the virtual servers and the physical servers is determined from an initial state where no virtual server is allocated to the physical servers. As a result, a completely new allocation relationship A(i)=j independent of the current allocation relationship is determined. Therefore, migration of a lot of virtual servers may be necessary at a time of actual server reassignment.

The migration of the virtual server carries some kind of risks, because specification and environment are in many cases different between the physical servers. Moreover, services provided by a certain virtual server are suspended during the migration of the certain virtual server. Although an optimum allocation relationship A(i)=j can be obtained according to the technique described in the First Section, the risks and service suspension time at the time of the server reassignment are increased if the migration of a lot of virtual servers are required. From this point of view, it is desirable that the number of virtual servers to be migrated is as small as possible.

According to an exemplary embodiment of the present invention, a technique that can suppress the number of virtual servers to be migrated at the time of actual server reassignment is provided. To that end, a suitable server reassignment plan is mechanically generated. That is, according to the exemplary embodiment of the present invention, a “server reassignment support system” that supports the server reassignment by generating a suitable server reassignment plan is provided.

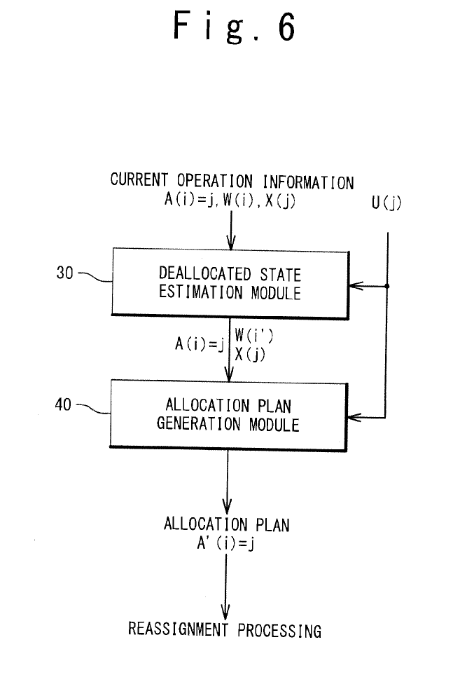

FIG. 6 schematically shows a configuration of the server reassignment support system according to the exemplary embodiment of the present invention. The server reassignment support system has a deallocated state estimation module 30 and the allocation plan generation module 40. The allocation plan generation module 40 has the same functions as described in the First Section. Let us consider a case where a plurality of virtual servers are currently allocated to a plurality of physical servers.

The deallocated state estimation module 30 receives current operation information. The current operation information includes a current allocation relationship A(i)=j between the virtual servers and the physical servers. Moreover, the current operation information includes the current resource usage W(i) of the virtual servers and the current resource usage X(j) of the physical servers. The resource usage X(j) is the sum of the resource usage W(i) of the virtual servers currently allocated, and can be said to be “load” with regard to the physical server. Furthermore, the deallocated state estimation module 30 receives information indicating the resource capacity U(j) of the physical servers.

The deallocated state estimation module 30 refers to the load (resource usage X(j)) and the resource capacity U(j) of each physical server to extract a physical server whose load exceeds a “threshold value” depending on its resource capacity U(j). Such a physical server is hereinafter referred to as an “overloaded server”. The above-mentioned “threshold value” may be the resource capacity U(j) itself or may be a value obtained by multiplying the resource capacity U(j) by a predetermined rate (e.g. 95%).

Further, the deallocated state estimation module 30 determines at least part of the virtual servers as a “deallocation candidate” and estimates a state in which the deallocation candidate has been deallocated. In particular, the deallocated state estimation module 30 estimates a state in which at least part of virtual servers currently allocated to the above-mentioned overloaded server has been deallocated. The “state” here means, for example, the load (resource usage X(j)) and the remaining amount (U(j)−X(j)) of the resource capacity of the respective physical servers when the deallocation candidate is deallocated. A virtual server i determined as the deallocation candidate is hereinafter referred to as a “deallocated server i′”. That is, the deallocated state estimation module 30 determines a deallocated server among the plurality of virtual servers and estimates (calculates) the load and the like of the respective physical servers when the deallocated server has been deallocated. For example, the deallocated state estimation module 30 refers to the resource usage W(i) of the virtual servers and the resource capacity U(j) of the overloaded server and thereby can determine the deallocated server so that the load of the overloaded server will became equal to or less than the above-mentioned threshold value.

Based on the state estimated by the deallocated state estimation module 30, the allocation plan generation module 40 determines re-allocation destination of the deallocated server, namely generates an allocation plan for the deallocated server. For example, the allocation plan generation module 40 receives information on the resource usage W(i′) of the deallocated server i′ that is determined by the deallocated state estimation module 30 and the load (resource usage X(j)) of the physical servers that is estimated by the deallocated state estimation module 30. Moreover, the allocation plan generation module 40 receives information on the resource capacity U(j) of each physical server. Further, the allocation plan generation module 40 may receive the allocation relationship A(i)=j. The allocation plan generation module 40 has the same functions as described in the First Section. Therefore, the allocation plan generation module 40 can generate an allocation plan for the deallocated server based on the received resource usage W(i′), resource usage X(j) and resource capacity U(j) (refer to FIG. 3).

Allocating (Step S40) of the deallocated server by the allocation plan generation module 40 is performed in the same manner as described in the First Section (refer to FIG. 4). That is, the allocation plan generation module 40 calculates the remaining amount (U(j)−X(j)) of the resource capacity of each physical server based on the received resource capacity U(j) and resource usage X(j). Then, the allocation plan generation module 40 refers to the calculated remaining amount and the resource usage W(i′) of the deallocated server to determine the allocation of the deallocated server. Consequently, a new allocation relationship A′(i)=j between the virtual servers and the physical servers is determined.

It should be noted that an object of the allocation processing in the present exemplary embodiment is the “deallocated server”. In the case of the foregoing FIG. 3, the allocation plan generation module 40 receives the resource usage W(i) of all the virtual servers. As a result, all the virtual servers becomes the object of the allocation processing, and hence a new allocation relationship determined is independent of the current allocation relationship A(i)=j. In the case of FIG. 6, on the other hand, the allocation plan generation module 40 receives the resource usage W(i′) of the deallocated server. Therefore, in the allocation processing, allocation of only the deallocated server instead of all the virtual servers is determined. In other words, only the allocation of the deallocated server is changed from the current one, and the allocation of the other virtual servers is not changed. As a result, a new allocation relationship A′(i)=j that is partially dependent on the current allocation relationship A(i)=j is determined. That is to say, only a part of the current allocation relationship A(i)=j is changed (updated).

The allocation plan generation module 40 outputs the determined allocation relationship A′(i)=j as the allocation plan. Alternatively, the allocation plan generation module 40 may outputs the allocation relationship A′(i′)=j regarding the deallocated server as the allocation plan. That is, the allocation plan indicates at least a new allocation destination of the deallocated server. The allocation plan corresponds to a plan of the server reassignment, namely the server reassignment plan. In this manner, the server reassignment support system shown in FIG. 6 mechanically generates the server reassignment plan. A user can actually carry out the server reassignment with reference to the generated server reassignment plan.

The number of virtual server migrated at the time of the server reassignment is at most the number of the deallocated servers. The reason is that the allocation of the virtual servers other than the deallocated servers is not changed. Therefore, the number of virtual servers to be migrated is suppressed as compared with a case where the technique described in the First Section is merely employed. As a result, the risks and the service suspension time at the time of the actual server reassignment can be reduced, which is preferable. Moreover, since only the deallocated server is the object of the allocation, a time required for generating the allocation plan is reduced. Thus, according to the present exemplary embodiment, a server reassignment plan suitable for the actual server reassignment can be mechanically generated in a short time. That is to say, the server reassignment is supported.

### 3. Example of Generation of Server Reassignment Plan

Next, a concrete example of the processing of generating the server reassignment plan will be described.

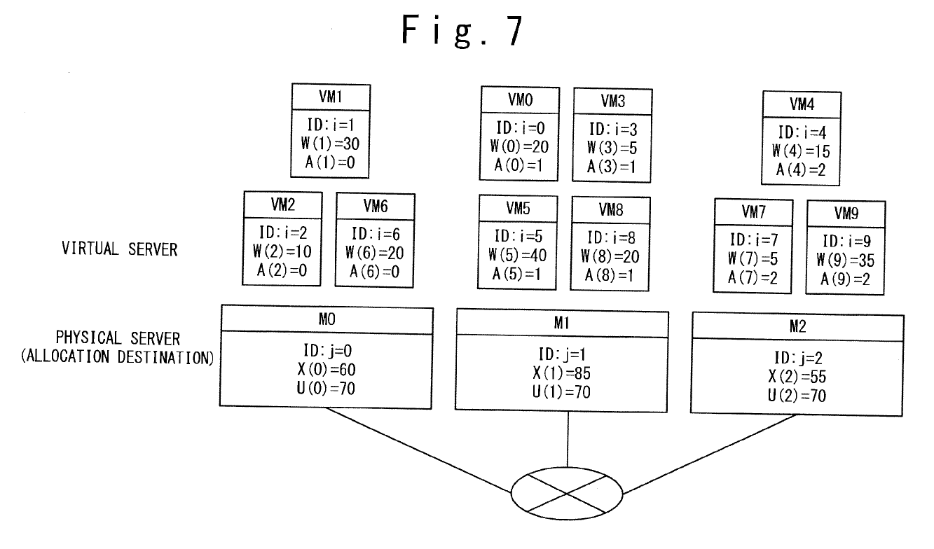

FIG. 7 shows an operation status of a server system. In FIG. 7, a plurality of virtual servers VM0 to VM9 operate on a plurality of physical servers M0 to M2. Integers i (=0 to 9) as ID numbers are added to the virtual servers VM0 to VM9, respectively. Integers j (=0 to 2) as ID numbers are added to the physical servers M0 to M2, respectively.

The virtual servers VM0 to VM9 each is allocated to any one of the physical servers M0 to M2. The current allocation relationship A(i)=j is as follows. That is, the virtual servers VM1, VM2 and VMG are allocated to the physical server M0 (A(1)=A(2)=A(6)=0). The virtual servers VM0, VM3, VM5 and VM8 are allocated to the physical server M1 (A(0)=A(3)=A(5)=A(8)=1). The virtual servers VM4, VM7 and VM9 are allocated to the physical server M2 (A(4)=A(7)=A(9)=2).

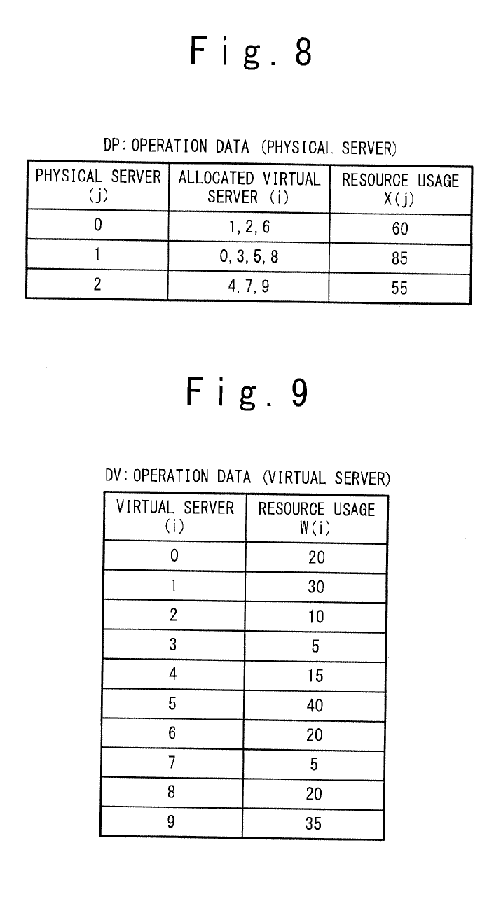

FIG. 8 and FIG. 9 show an example of operation data (DP, DV) indicating a current operation status. The operation data DP shown in FIG. 8 indicates an operation status of the physical servers. More specifically, the operation data DP indicates the current resource usage X(j) of each physical server and the current allocation relationship A(i)=j between the physical servers and the virtual servers. An operation data DV shown in FIG. 9 indicates an operation status of the virtual servers. More specifically, the operation data DV indicates the resource usage W (i) of each virtual server. In the example shown in FIG. 7 and FIG. 9, W(0)=20, W(1)=30, W(2)=10, W(3)=5, W(4)=15, W(5)=40, W(6)=20, W(7)=5, W(8)=20 and W(9)=35.

The resource usage X(j) of a physical server shown in FIG. 8 is the sum of the resource usage W(i) of the virtual servers currently allocated, and can be said to be the “load” with regard to the physical server. In the example shown in FIG. 7 and FIG. 8, X(0)=60, X(1)=85 and X(2)=55.

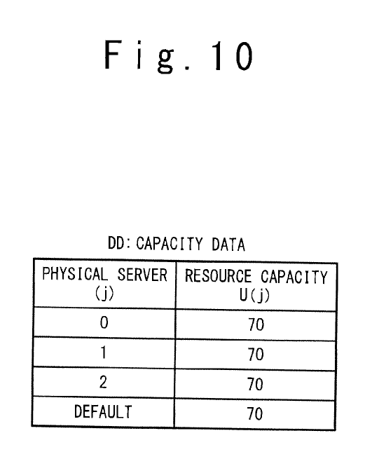

FIG. 10 shows an example of the capacity data DD indicating the resource capacity U(j) of each physical server. In the example shown in FIG. 7 and FIG. 10, U(0)=U(1)=U(2)=70. Also, the capacity data DD indicates the resource capacity U (default value) of an additional physical server. In the present example, the default value U also is 70. Note that the resource capacities U(j) and U can be different from each other.

If the resource usage X(j) of a certain physical server j exceeds a threshold value depending on the resource capacity U(j) of the certain physical server j, the certain physical server j is an overloaded server. The threshold value may be the resource capacity U(j) itself or may be a value obtained by multiplying the resource capacity 15(j) by a predetermined rate. In the description below, let us consider a case where the threshold value is equal to the resource capacity U(j). When an overloaded server occurs, it greatly deteriorates the performance of not only the overloaded server but also the virtual servers operating thereon. It is therefore necessary to perform reassignment of virtual serves so that the overloaded state is resolved. In the example shown in FIG. 7, the physical server M1 (j=1) is an overloaded server (X(l)=85, U(l)=70). Therefore, a server reassignment plan with which the overloaded state of the physical server M1 can be resolved is generated.

### 3-1. First Exemplary Embodiment

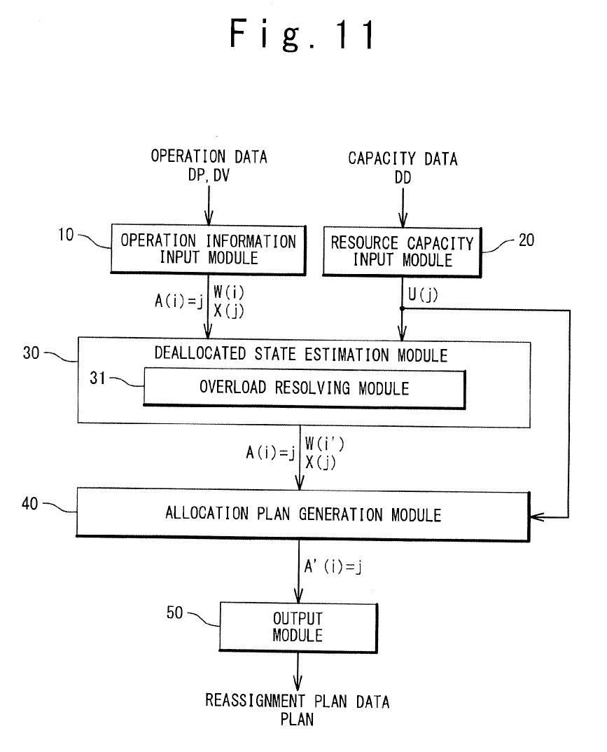

FIG. 11 is a block diagram showing a configuration of the server reassignment support system according to a first exemplary embodiment. In FIG. 11, the server reassignment support system has an operation information input module 10, a resource capacity input module 20, the deallocated state estimation module 30, the allocation plan generation module 40 and an output module 50. The deallocated state estimation module 30 includes an overload resolving module 31.

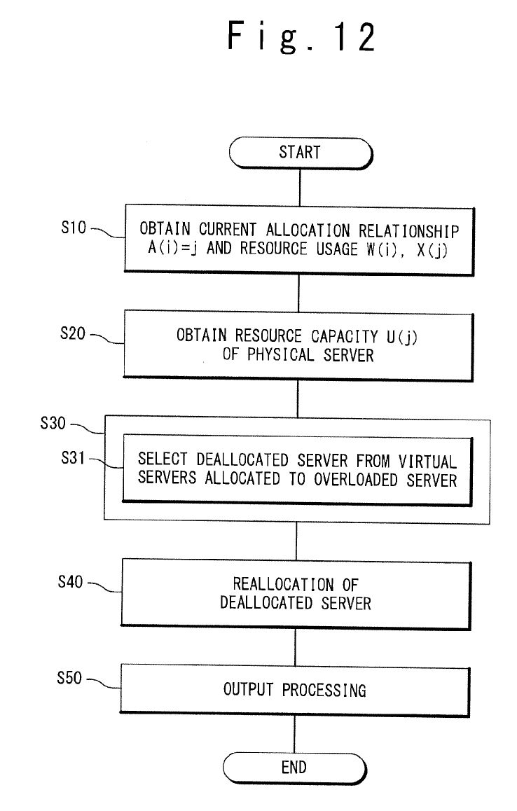

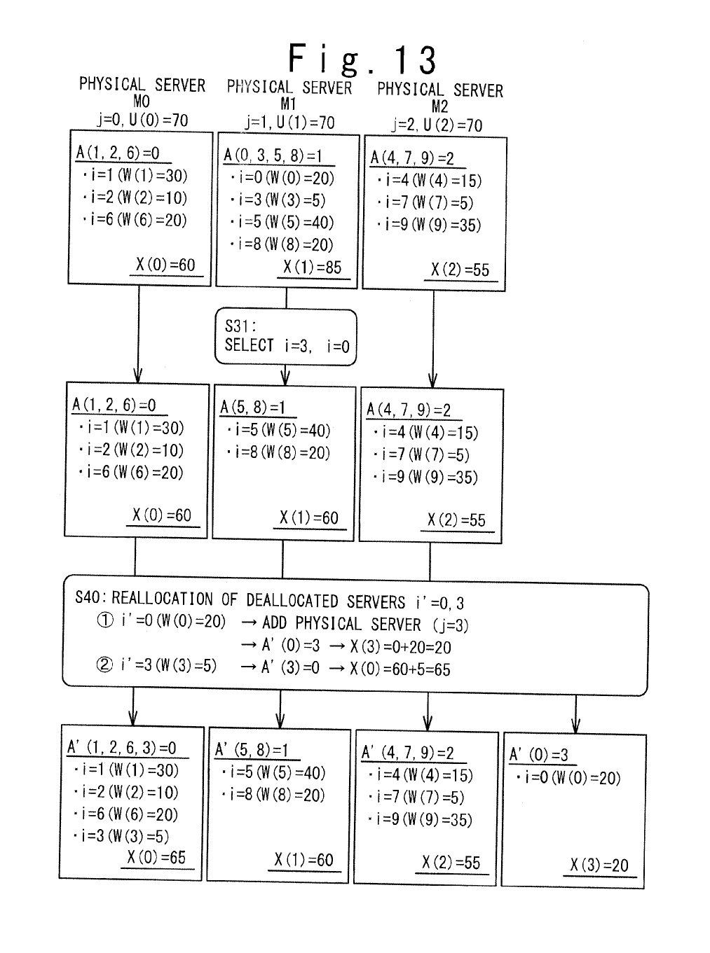

FIG. 12 is a flow chart showing the processing of generating the server reassignment plan in the first exemplary embodiment. FIG. 13 shows an example of the processing with respect to the operation status shown in the foregoing FIG. 7. The processing of generating the server reassignment plan in the first exemplary embodiment will be described with reference to FIGS. 11 to 13.

Step S10:

The operation information input module 10 reads the operation data DP and DV shown in FIG. 8 and FIG. 9 from a storage device (described later). Thus, the server reassignment support system obtains the current allocation relationship A(i)=j, the resource usage W(i) of the virtual servers and the current resource usage X(j) of the physical servers. The operation information input module 10 outputs the operation data DP and DV (A(i)=j, W(i), X(j)) to the deallocated state estimation module 30.

Step S20:

The resource capacity input module 20 reads the capacity data DD shown in FIG. 10 from a storage device (described later). Thus, the server reassignment support system obtains the resource capacity U(j) of the physical servers. The resource capacity input module 20 outputs the capacity data DD (U(j)) to the deallocated state estimation module 30 and the allocation plan generation module 40.

Step S30:

The deallocated state estimation module 30 refers to the operation data DP, DV and the capacity data DD to extract an overloaded server from the physical servers and determines a deallocated server among the virtual servers.

More specifically, the overload resolving module 31 refers to the current resource usage X(j) and the resource capacity U(j) to extract the overloaded server [j=1] whose load exceeds its resource capacity U(j). Moreover, the overload resolving module 31 selects at least part of the virtual servers [i=0, 3, 5, 8] allocated to the overloaded server, as the deallocated server (Step S31). At this time, the overload resolving module 31 can select the deallocated server so that the resource usage X(1) becomes equal to or less than the resource capacity U(1), by referring to the resource usage W(0), W(3), W(5) and W(8) of the virtual servers, and to the resource usage X(1) and the resource capacity U(1) of the overloaded server. More specifically, the overload resolving module 31 selects the deallocated server one-by-one from the virtual servers [i=0, 3, 5, 8] in accordance with a predetermined policy until the overloaded state is resolved. The policy is exemplified by random, descending or ascending order of the resource usage W(i) of the virtual servers.

For example, the deallocated server is selected in descending order of the resource usage W(i). In this case, it is expected that the overloaded state can be resolved with a relatively small number of deallocated servers. In other words, a total number of deallocated servers is suppressed. This is preferable in that the number of virtual servers to be migrated at the time of actual server reassignment is suppressed.

On the other hand, in a case where the deallocated server is selected in ascending order of the resource usage W(i), a virtual server whose resource usage W(i) is relatively small is migrated at the time of actual server reassignment. The resource usage W(i) of a certain virtual server i being small means that a small number of users are utilizing the certain virtual server i. As described above, the migration of the virtual server carries some kind of risks, and services are suspended during the migration of the virtual server. Therefore, to preferentially migrate a virtual server whose resource usage W(i) is relatively small is preferable in terms of minimizing the risks and influences accompanying the migration. Furthermore, when the resource usage W(i) of the deallocated server is small, the deallocated server can be easily allocated to a currently-available physical server. That is, probability that the server reassignment will be achieved only with the existing physical servers without adding a new physical server can be increased. From this point of view, it is also preferable to select the deallocated server in ascending order of the resource usage W(i).

In the present exemplary embodiment, let us consider a case where the ascending order is employed. That is, the deallocated server is selected one-by-one in ascending order of the resource usage W(i) until the resource usage X(1) of the overloaded server [j=1] becomes equal to or less than the resource capacity U(1).

Referring to FIG. 13, it is the virtual server [i=3] whose resource usage W(i) is the minimum among the virtual servers [i=0, 3, 5, 8] currently allocated to the overloaded server [j=1]. Therefore, the virtual server [i=3] is first selected as the deallocated server i′. If the deallocated server [i′=3] is deallocated, the resource usage X(1) is decreased by the resource usage W(3) to be 80 (=85−5). However, the overloaded state is not yet resolved, and hence a next deallocated server is selected. The virtual servers [i=0, 8] each has the next smallest resource usage W(i). Here, let us consider a case where the virtual server [i=0] is selected as a deallocated server i′. If the deallocated server [i′=0] is further deallocated, the resource usage X(1) is decreased from 80 to 60. It is thus expected that the overloaded state is resolved.

In this manner, the overload resolving module 31 selects the virtual servers [i=3, 0] as the deallocated servers. Moreover, the overload resolving module 31 calculates (estimates) the resource usage X(1) under a condition that the deal located servers are deallocated from the overloaded server [j=1], and updates the resource usage X(1) from 85 to 60. Then, the overload resolving module 31 outputs the resource usage W(i′) of the selected deallocated servers and the updated resource usage X(j) to the allocation plan generation module 40.

Step S40:

The allocation plan generation module 40 receives the resource usage W(i′) of the deallocated servers, the updated resource usage X(j) and the resource capacity (U(j), U) of the physical servers. Then, the allocation plan generation module 40 determines allocation of the deallocated servers again with reference to the resource usage W(i′) of the deallocated servers and the remaining amount of the resource capacity of the physical server. Here, the remaining amount of the resource capacity of the physical server is the difference U(j)−X(j) between the resource capacity U(j) and the resource usage X(j). A method of allocating the deallocated servers is the same as that described in the First Section (refer to FIG. 3 to FIG. 5). That is, the allocation of the deallocated servers are determined in descending order of the resource usage W(i′). Moreover, a deallocated server with larger resource usage W (i′) is allocated to a physical server with smaller remaining amount U(j)−X(j).

Referring to FIG. 13, the resource usage W(3) of the deallocated server [i′=3] is 5, and the resource usage W(0) of the deallocated server [i′=0] is 20. In this case, the above-mentioned array S is represented by S=[0, 3] (S(k=0)=0, S(k=1)=3). Therefore, the allocation is determined in the order of i′=0, 3.

The updated resource usage X(0), X(1) and X(2) of the physical servers are 60, 60 and 55, respectively. Therefore, the respective remaining amounts of the resource capacity are 10 (j=0), 10 (j=1) and 15 (j=2). In this case, the above-mentioned array T is represented by T=[0, 1, 2] (T(l=0)=0, T(l=1)=1, T(l=2)=2). Therefore, an object of the comparison processing is selected in the order of j=0, 1, 2.

First, the allocation processing for the deallocated server [i′=0] is performed. In this case, the resource usage W(0) is more than the remaining amount of any physical server. Therefore, a new physical server [j=3] is added. The resource capacity U(3) of the added physical server [j=3] is the default value (=70), and the resource usage X(3) is the initial value (=0). The deallocated server [i′=0] is allocated to the physical server [j=3] (A′(0)=3). As a result, the resource usage X(3) becomes 20.

Next, the allocation processing for the deallocated server [i′=3] is performed. In this case, the resource usage W(3) is not more than the remaining amount of the physical server [j=0] Therefore, the deallocated server [i′=3] is allocated to the physical server [j=0] (A′(3)=0). As a result, the resource usage X(0) becomes 65 (=60+5).

In this manner, the allocation plan generation module 40 modifies only a part of the current allocation relationship A(i)=j to generate a new allocation relationship A′(i)=j. In the first exemplary embodiment, the allocation destination of the virtual server [i=0] is changed from the physical server [j=1] to the physical server [j=3], and the allocation destination of the virtual server [i=3] is changed from the physical server [j=1] to the physical server [j=0]. Therefore, the overloaded state of the physical server [j=1] can be resolved by migrating just two virtual servers [i=0, 3] at the time of the actual server reassignment.

Note that the remaining amount of the resource capacity was the same between the physical server [j=0] and the physical server [j=1]. Therefore, the above-mentioned array T can be T=[1, 0, 2] instead of T=[0, 1, 2]. In this case, the deallocated server [i′=3] is allocated to the original physical server [j=1] (A′(3)=1). Therefore, the overloaded state of the physical server [j=1] can be resolved by migrating only one virtual server [i=0] at the time of the actual server reassignment.

Step S50:

The output module 50 receives the allocation plan (A′(i)=j) generated by the allocation plan generation module 40. Then, the output module 50 refers to the generated allocation plan and outputs a reassignment plan data PLAN indicating information useful for the server reassignment to an output device (described later). For example, the reassignment plan data PLAN may indicate not only the allocation plan but also a required number n of physical servers, a predicted value of the resource usage X(j) after the reassignment and the like. The information useful for the server reassignment is the server reassignment plan, which is for example displayed on a display device. For example, the deallocated server ID, the migration destination of the deallocated server, the required number of physical servers, notice of the addition of the new physical server and the like are displayed on the display device in the present exemplary embodiment.

As described above, according to the server reassignment plan generated in the first exemplary embodiment, the overloaded state can be resolved by migration (reassignment) of a minimal necessary number of the virtual servers. As a result, the risks and service suspension time at the time of the server reassignment can be greatly reduced.

### 3-2. Second Exemplary Embodiment

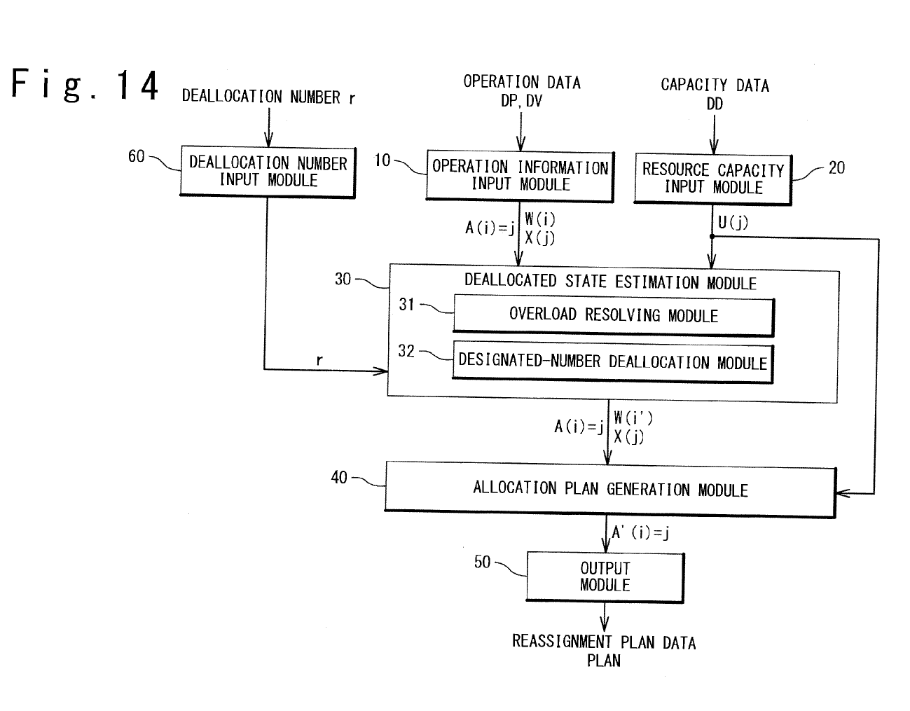

FIG. 14 is a block diagram showing a configuration of the server reassignment support system according to a second exemplary embodiment. The server reassignment support system according to the second exemplary embodiment has a deallocation number input module 60 in addition to the configuration in the first exemplary embodiment. Moreover, the deallocated state estimation module 30 includes a designated-number deallocation module 32 in addition to the overload resolving module 31.

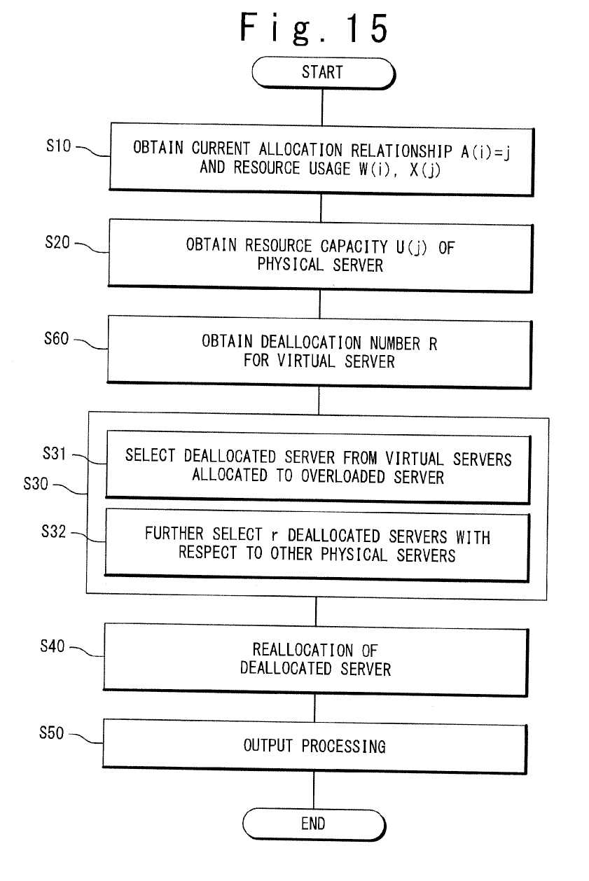

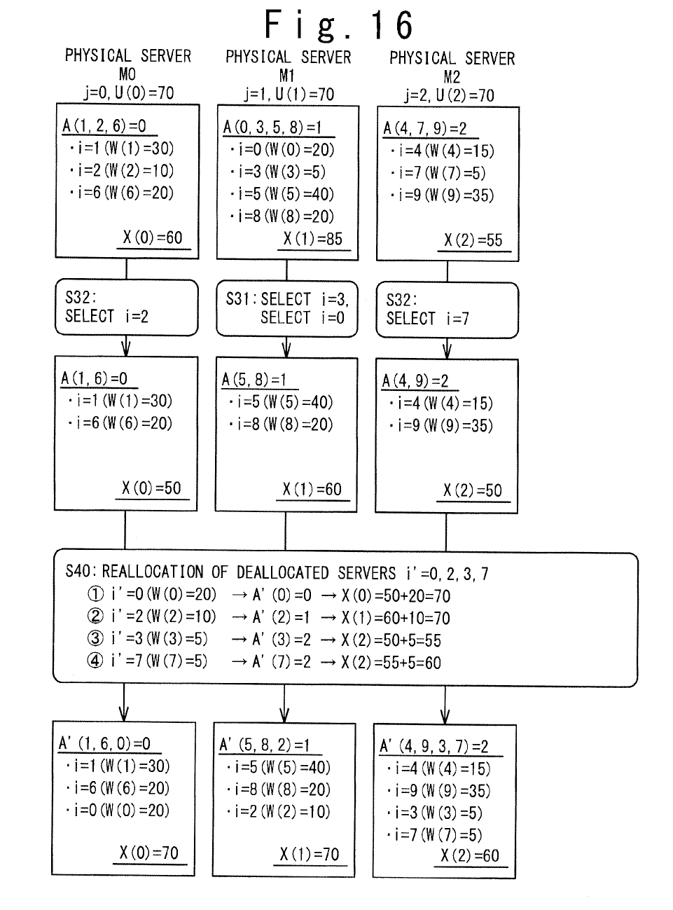

FIG. 15 is a flow chart showing the processing of generating the server reassignment plan in the second exemplary embodiment. FIG. 16 shows an example of the processing with respect to the operation status shown in the foregoing FIG. 7. The processing of generating the server reassignment plan in the second exemplary embodiment will be described with reference to FIGS. 14 to 16. An overlapping description as in the first exemplary embodiment will be omitted as appropriate.

The Step S10 and Step S20 are the same as in the first exemplary embodiment.

Step S60:

The deallocation number input module 60 obtains a parameter r. As described later, the parameter r is referred to by the deallocated state estimation module 30 when selecting the deallocated server, and is hereinafter referred to as a “deallocation number r”. The deallocation number r is designated by a user, for example.

The deallocation number input module 60 notifies the deallocated state estimation module 30 of the deallocation number r. In the present example, the deallocation number r is 1.

Step S30:

The Step S31 is the same as in the first exemplary embodiment. That is, the overload resolving module 31 extracts the overloaded server [j=1] and selects the virtual servers [i=0, 3] allocated to the overloaded server as the deallocated servers. The resource usage X(1) is modified from 85 to 60.

Meanwhile, the designated-number deallocation module 32 selects the designated deallocation number r of virtual server with respect to each of the physical servers [j=0, 2] other than the overloaded server (Step S32). In this case also, the virtual servers are selected one-by-one in accordance with a predetermined policy. The policy is exemplified by random, descending or ascending order of the resource usage W(i) of the virtual servers. In the present exemplary embodiment, the designated-number deallocation module 32 refers to the resource usage W(i) and selects the virtual servers in ascending order of the resource usage W(i). The virtual server selected by the designated-number deallocation module 32 also is treated as the deallocated server. That is to say, the designated-number deallocation module 32 selects some from the virtual servers allocated to other servers than the overloaded server and adds the selected virtual servers further into the deallocated servers.

Referring to FIG. 16, it is the virtual server [i=2] whose resource usage W(i) is the minimum among the virtual servers [i=1, 2, 6] currently allocated to the physical server [j=0]. Therefore, the designated-number deallocation module 32 selects the virtual server [i=2] and adds it into the deallocated servers. Since the deallocation number r is 1, the processing with regard to the physical server [j=0] is completed. The resource usage X(0) is modified from 60 to 50.

Similarly, it is the virtual server [i=7] whose resource usage W(i) is the minimum among the virtual servers [i=4, 7, 9] currently allocated to the physical server [j=2]. Therefore, the designated-number deallocation module 32 selects the virtual server [i=7] and adds it into the deallocated servers. The resource usage X(2) is modified from 55 to 50.

Four deallocated servers i′=0, 2, 3 and 7 are thus selected by the deallocated state estimation module 30 in the present exemplary embodiment. The deallocated state estimation module 30 outputs the resource usage W(i′) of the deallocated servers [i′=0, 2, 3, 7] and the updated resource usage X(j) to the allocation plan generation module 40.

As to the overloaded server [j=1], the overload resolving module 31 has already selected the two virtual servers [i=0, 3]. The designated-number deallocation module 32 needs not select further. Alternatively, the designated-number deallocation module 32 may further select r virtual server from the overloaded server.

Step S40:

As in the case of the first exemplary embodiment, the allocation plan generation module 40 determines the allocation of the deallocated servers again. The processing object is all the deallocated servers [i′=0, 2, 3, 7] selected by the deallocated state estimation module 30.

Referring to FIG. 16, the resource usage W(0), W(2), W(3) and W(7) are 20, 10, 5 and 5, respectively. In this case, the above-mentioned array S is represented by S=[0, 2, 3, 7]. Therefore, the allocation is determined in the order of i′=0, 2, 3, 7.

The updated resource usage X(0), X(1) and X(2) of the physical servers are 50, 60 and 50, respectively. Therefore, the respective remaining amounts of the resource capacity are 20 (j=0), 10 (j=1) and 20 (j=2). In this case, the above-mentioned array T is represented by T=[1, 0, 2]. Therefore, an object of the comparison processing is selected in the order of j=1, 0, 2.

First, the allocation processing for the deallocated server [i′=0] is performed. In this case, the resource usage W(0) is not more than the remaining amount of the physical server [j=0]. Therefore, the deallocated server [i′=0] is allocated to the physical server [j=0] (A′(0)=0). As a result, the resource usage X(0) becomes 70 (=50+20).

Next, the allocation processing for the deallocated server [i′=2] is performed. In this case, the resource usage W(2) is not more than the remaining amount of the physical server [j=1]. Therefore, the deallocated server [i′=2] is allocated to the physical server [j=1] (A′(2)=1). As a result, the resource usage X(1) becomes 70 (=60+10).

Next, the allocation processing for the deallocated server [i′=3] is performed. In this case, the resource usage W(3) is not more than the remaining amount of the physical server [j=2]. Therefore, the deallocated server [i′=3] is allocated to the physical server [j=2] (A′(3)=2). As a result, the resource usage X(2) becomes 55 (=50+5).

Last of all, the allocation processing for the deallocated server [i′=7] is performed. In this case, the resource usage W(7) is not more than the remaining amount of the physical server [j=2]. Therefore, the deallocated server [i′=7] is allocated to the physical server [j=2] (A′(7)=2). As a result, the resource usage X(2) becomes 60 (=55+5).

In this manner, the allocation destination of the virtual server [i=0] is changed from the physical server [j=1] to the physical server [j=0], the allocation destination of the virtual server [i=2] is changed from the physical server [j=0] to the physical server [j=1], and the allocation destination of the virtual server [i=3] is changed from the physical server [j=1] to the physical server [j=2]. The allocation destination of the virtual server [i=7] is unchanged at the physical server [j=2]. Thus, the overloaded state of the physical server [j=1] can be resolved by migrating just three virtual servers [i=0, 2, 3] at the time of the actual server reassignment.

As described above, according to the server reassignment plan generated in the second exemplary embodiment, the overloaded state can be resolved by a small number of migrations. Although the number of migrations is slightly larger than that in the first exemplary embodiment, the number is suppressed as compared with a case where the technique described in the First Section is merely employed. As a result, the risks and the service suspension time at the time of the server reassignment can be reduced.

Meanwhile, according to the second exemplary embodiment, the new physical server [j=3] is not added, which is different from the first exemplary embodiment. In other words, the total number of the physical servers after the reallocation processing becomes smaller than that in the first exemplary embodiment. This is because the deallocated servers are further selected by the designated-number deallocation module 32. Less physical servers required for resolving the overloaded state means that less cost being required for the server reassignment. It can be said that the second exemplary embodiment enables both the reduction of the number of virtual servers to be migrated and the suppression of the total number of required physical servers.

### 3-3. Third Exemplary Embodiment

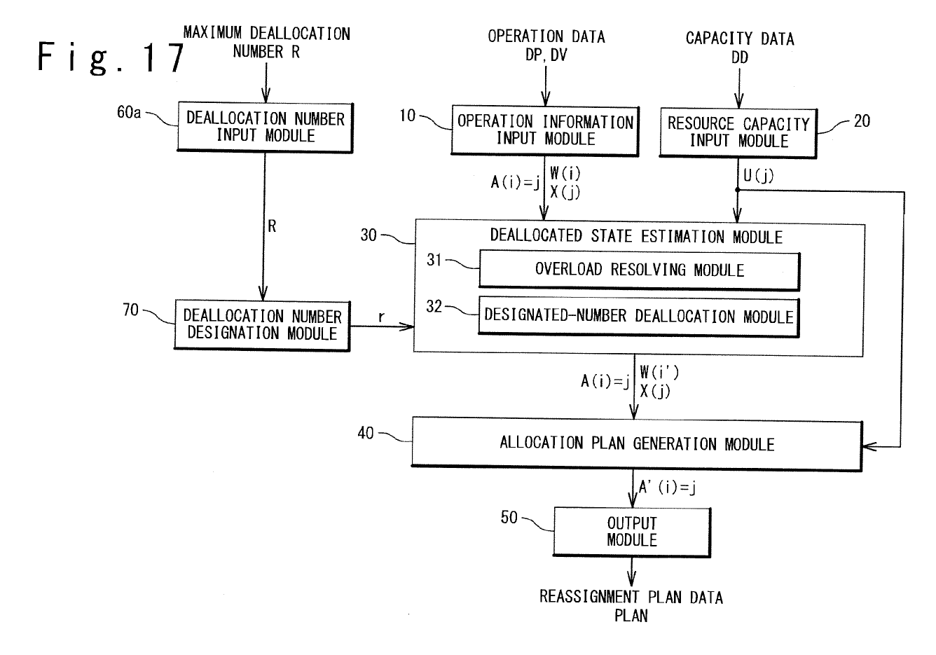

FIG. 17 is a block diagram showing a configuration of the server reassignment support system according to a third exemplary embodiment. The server reassignment support system according to the third exemplary embodiment has a deallocation number designation module 70 in addition to the configuration in the second exemplary embodiment. Moreover, a deallocation number input module 60a providing similar functions is used instead of the deallocation number input module 60. An overlapping description as in the second exemplary embodiment will be omitted as appropriate.

As in the case of the second exemplary embodiment, the deallocation number input module 60a obtains a deallocation number. Note that in the third exemplary embodiment, the deallocation number input module 60a obtains a “maximum deallocation number R” that is the maximum value of the deallocation number r. The maximum deallocation number R is an integer equal to or more than 0, and is designated by a user for example.

The deallocation number designation module 70 designates a plurality kinds of values in order as the deallocation number r for the deal located state estimation module 30. At this time, the deallocation number designation module 70 refers to the maximum deallocation number R and designates the deallocation number r one-by-one within a range from 0 to the maximum deallocation number R. For example, the deallocation number designation module 70 increases the deallocation number r from 0 up to the maximum deallocation number R in order.

When a deallocation number r is designated, the deallocated state estimation module 30, the allocation plan generation module 40 and the output module 50 perform the same processing as in the second exemplary embodiment. That is, the above-described Steps S30, S40 and S50 are performed every time the deallocation number r is designated. In a case where the maximum deallocation number R is 3, for example, the deallocation number r is set to each of 0, 1, 2 and 3 and thus the Steps S30 to S50 are repeated four times. As a result, four kinds of server reassignment plans are generated. Thus, a user can select an optimum one from the plurality of server reassignment plans generated.

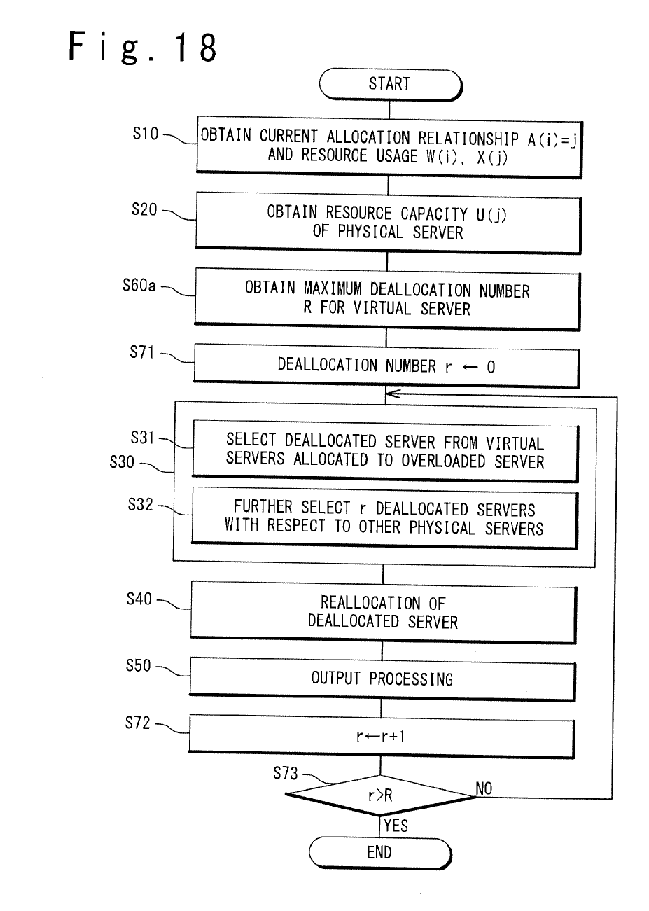

FIG. 18 is a flow chart showing the processing of generating the server reassignment plan in the third exemplary embodiment. An example of the processing of generating the server reassignment plan in the third exemplary embodiment will be described with reference to FIGS. 17 and 18. In the present example, the maximum deallocation number R is 1.

The Steps S10 and S20 are the same as in the foregoing exemplary embodiment. In Step S60a, the deallocation number input module 60a obtains the maximum deallocation number R. Subsequently, the deallocation number designation module 70 initializes the deallocation number r to be an initial value 0 (Step S71).

The Steps S30 to S50 are performed under a condition of deallocation number r=0. The processing in this case is substantially the same as in the example described in the first exemplary embodiment (refer to FIG. 13). Therefore, the same server reassignment plan as in the first exemplary embodiment is generated.

Next, the deallocation number designation module 70 adds 1 to the deallocation number r (Step S72). The deallocation number r (=1) is not more than the maximum deallocation number R (=1) (Step S73; No). Therefore, the Steps S30 to S50 are performed under a condition of deallocation number r=1. The processing in this case is substantially the same as in the example described in the second exemplary embodiment (refer to FIG. 16). Therefore, the same server reassignment plan as in the second exemplary embodiment is generated.

Next, the deallocation number designation module 70 further adds 1 to the deallocation number r (Step S72). Since the deallocation number r (=2) exceeds the maximum deallocation number R (=1) (Step S73; Yes), the processing ends.

According to the third exemplary embodiment, as described above, the deallocation number r is set to a plurality of values in order. Consequently, a list of server reassignment plans is generated. A user can easily select an optimum server reassignment plan by weighing the migration number of virtual server, the total number of required physical servers, costs and so forth.

### 4. System Configuration

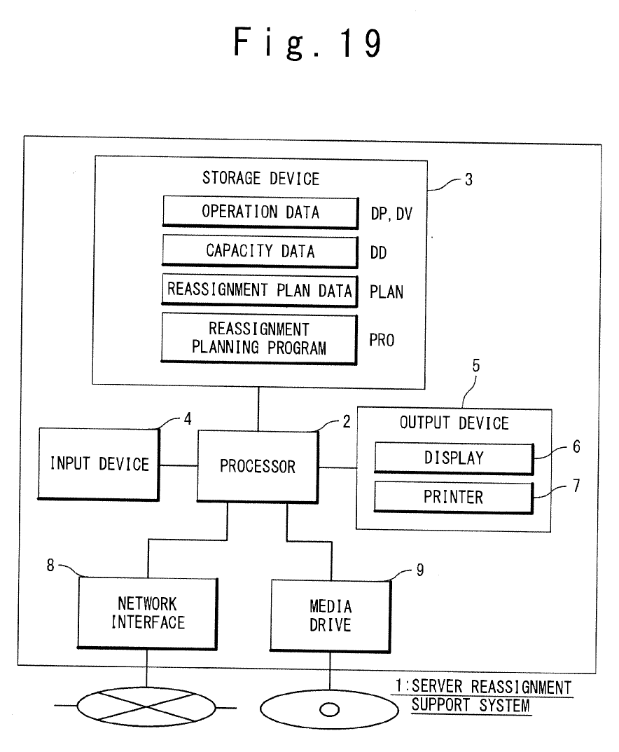

The configuration and processing according to the foregoing exemplary embodiments can be achieved by a computer system. FIG. 19 shows an example of a server reassignment support system 1 that supports the server reassignment. The server reassignment support system 1 is a computer system and is constructed on, for example, a management server.

In FIG. 19, the server reassignment support system 1 is provided with a processor 2, a storage device 3, an input device 4, an output device 5, a network interface 8 and a media drive 9. The processor 2 including a CPU executes various processing and controls operations of the respective devices. The storage device 3 includes a RAM and a hard disk drive. The input device 4 is exemplified by a keyboard and a mouse. The output device 5 includes a display device 6 and a printer 7. A user can refer to information displayed on the display device 6 and input various data and commands by using the input device 4.

The operation data DP, DV, the capacity data DD and the like are stored in the storage device 3. These data may be input with the input device 4 or may be provided through the network interface 8. Or, those data may be recorded on a computer-readable recording medium and read by the media drive 9.

Furthermore, a reassignment planning program PRO is stored in the storage device 3. The reassignment planning program PRO is software executed by the processor 2. For example, the reassignment planning program PRO is recorded on a computer-readable recording medium and read by the media drive 9. Or, the reassignment planning program PRO may be provided through the network interface 8.

By executing the reassignment planning program PRO, the processor 2 achieves the processing of generating the reassignment plan according to the foregoing exemplary embodiments. That is to say, cooperation of the processor 2 and the reassignment planning program PRO provides the operation information input module 10, the resource capacity input module 20, the deallocated state estimation module 30, the allocation plan generation module 40, the output module 50, the deallocation number input modules 60, 60a, and the deallocation number designation module 70.

Each module reads necessary data from the storage device 3, receives necessary data from the input device 4 or other modules. For example, the operation information input module 10 reads the operation data DP and DV from the storage device 3. The deallocation number input module 60 receives the deallocation number r or the maximum deallocation number R from the input device 4. Then, the respective modules execute processing described in the foregoing exemplary embodiments. Consequently, the reassignment plan data PLAN indicating the server reassignment plan is generated. The generated reassignment plan data PLAN is stored in the storage device and output through the output device 5. For example, the reassignment plan data PLAN is displayed on the display device 6. A user can perform the server reassignment with reference to the output server reassignment plan.

### 5. Modification Example

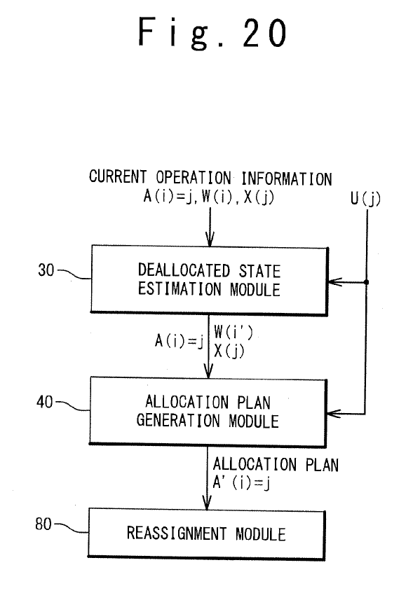

A computer may automatically perform the server reassignment in accordance with the generated server reassignment plan. For example, as shown in FIG. 20, a reassignment module 80 actually carries out reassignment (migration) of the virtual servers in accordance with the allocation plan generated by the allocation plan generation module 40.

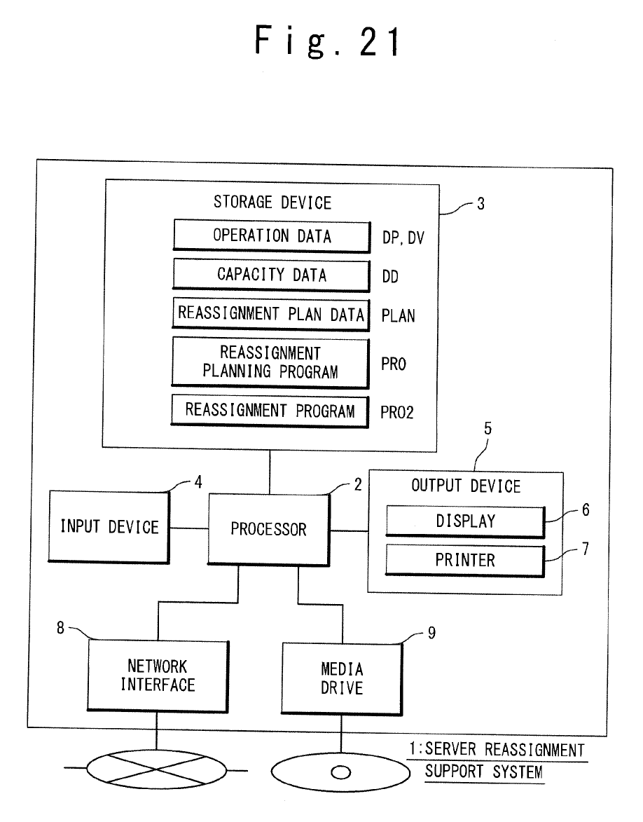

FIG. 21 shows an example of the system configuration in the case of FIG. 20. The same reference numerals are given to the same components as those shown in FIG. 19, and an overlapping description will be omitted. A reassignment program PRO2 is further stored in the storage device 3. The reassignment program PRO2 is software executed by the processor 2. For example, the reassignment program PRO2 is recorded on a computer-readable recording medium and read by the media drive 9. Or, the reassignment program PRO2 may be provided through the network interface 8. Cooperation of the processor 2 and the reassignment program PRO2 provides the reassignment module 80 shown in FIG. 20.

For example, the reassignment program PRO2 (reassignment module 80) can be realized by “VMware (trademark) VMotion (trademark)” by VMware Inc. (refer to http://www.vmware.com/ja/products/vi/vc/vmotion.html, http://www.vmware.com/products/vi/vc/vmotion.html).

The reassignment program PRO2 may be provided integrally with the above-mentioned reassignment planning program PRO.

While the exemplary embodiments of the present invention have been described above with reference to the attached drawings, the present invention is not limited to these exemplary embodiments and can be modified as appropriate by those skilled in the art without departing from the spirit and scope of the present invention.

This application is based upon and claims the benefit of priority from Japanese patent application No. 2007-240964, filed on Sep. 18, 2007, the disclosure of which is incorporated herein in its entirely by reference.

1. A server reassignment support system that supports reassignment of a plurality of virtual servers allocated to a plurality of physical servers, comprising:
a storage device in which an operation data indicating operation status of said plurality of physical servers and said plurality of virtual servers and a capacity data indicating resource capacity of each of said plurality of physical servers are stored;
a deallocated state estimation module configured to refer to said operation data and said capacity data to extract an overloaded server from said plurality of physical servers, load of said overloaded server exceeding a threshold value depending on said resource capacity, and to estimate a state in which at least part of virtual servers allocated to said overloaded server is deallocated as a deallocated server among said plurality of virtual servers; and
an allocation plan generation module configured to generate an allocation plan for said deallocated server based on said estimated state.

2. The server reassignment support system according to claim 1,
wherein said operation data includes:
a data indicating allocation relationship between said plurality of physical servers and said plurality of virtual servers; and
a data indicating resource usage of each of said plurality of virtual servers,
wherein load of a certain physical server among said plurality of physical servers is sum of said resource usage of virtual servers allocated to said certain physical server,
wherein said deallocated state estimation module refers to said resource usage and said resource capacity to determine said deallocated server so that the load of said overloaded server becomes equal to or less than said threshold value, and estimates the load of each of said plurality of physical servers when said deallocated server is deallocated, and
wherein said allocation plan generation module generates said allocation plan based on said estimated load, said resource capacity and said resource usage of said deallocated server.

3. The server reassignment support system according to claim 2,
wherein said deallocated state estimation module selects said deallocated server one-by-one in ascending order of said resource usage from the virtual servers allocated to said overloaded server until the load of said overloaded server becomes equal to or less than said threshold value.

4. The server reassignment support system according to claim 2,
wherein said deallocated state estimation module selects a designated deallocation number of virtual server with respect to each of said plurality of physical servers other than said overloaded server, adds said selected virtual server further as said deallocated server, and estimates the load of each of said plurality of physical servers when said deallocated server is deallocated from said plurality of physical servers.

5. The server reassignment support system according to claim 4,
wherein said deallocated state estimation module selects said designated deallocation number of virtual servers one-by-one in ascending order of said resource usage.

6. The server reassignment support system according to claim 4, further comprising: a deallocation number designation module configured to designate a plurality of values in order as said deallocation number,
wherein every time said deallocation number is designated, said deallocated state estimation module performs processing with reference to said designated deallocation number and said allocation plan generation module generates said allocation plan.

7. The server reassignment support system according to claim 2,
wherein said allocation plan generation module calculates remaining amount of said resource capacity of each of said plurality of physical servers based on said resource capacity and said estimated load of said plurality of physical servers, and
said allocation plan generation module determines allocation of said deallocated server with reference to said remaining amount and said resource usage of said deallocated server to generate said allocation plan.

8. The server reassignment support system according to claim 7,
wherein said allocation plan generation module determines the allocation of said deallocated server in descending order of said resource usage.

9. The server reassignment support system according to claim 8,
wherein said allocation plan generation module selects said deallocated server one-by-one in descending order of said resource usage, selects any one of said plurality of physical servers, and makes a comparison between a comparison-object usage, which is said resource usage of said selected deallocated server, and said remaining amount of said selected physical server,
wherein if said comparison-object usage is more than said remaining amount, said allocation plan generation module selects another physical server different from said selected physical server and then carries out said comparison again, and
wherein if said comparison-object usage is not more than said remaining amount, said allocation plan generation module allocates said selected deallocated server to said selected physical server.

10. The server reassignment support system according to claim 9,
wherein said allocation plan generation module selects an object of said comparison from said plurality of physical servers in ascending order of said remaining amount.

11. The server reassignment support system according to claim 9,
wherein if said comparison-object usage is more than said remaining amount of every one of said plurality of physical servers, said allocation plan generation module allocates said selected deallocated server to a different physical server from said plurality of physical servers.

12. The server reassignment support system according to claim 1, further comprising: a display device configured to display said generated allocation plan.

13. The server reassignment support system according to claim 1, further comprising: a reassignment module configured to perform the reassignment of said plurality of virtual servers in accordance with said generated allocation plan.

14. A server reassignment support method for supporting, by using a computer, reassignment of a plurality of virtual servers allocated to a plurality of physical servers, comprising:
reading an operation data indicating operation status of said plurality of physical servers and said plurality of virtual servers from a storage device;
reading a capacity data indicating resource capacity of each of said plurality of physical servers from a storage device;
extracting an overloaded server from said plurality of physical servers, load of said overloaded server exceeding a threshold value depending on said resource capacity, with reference to said operation data and said capacity data;
estimating a state in which at least part of virtual servers allocated to said overloaded server is deallocated as a deallocated server among said plurality of virtual servers; and
generating an allocation plan for said deallocated server based on said estimated state.

15. The server reassignment support method according to claim 14,
wherein said operation data includes:
a data indicating allocation relationship between said plurality of physical servers and said plurality of virtual servers; and
a data indicating resource usage of each of said plurality of virtual servers,
wherein load of a certain physical server among said plurality of physical servers is sum of said resource usage of virtual servers allocated to said certain physical server,
wherein said estimating the state comprises:
determining said deallocated server with reference to said resource usage and said resource capacity so that the load of said overloaded server becomes equal to or less than said threshold value; and
estimating the load of each of said plurality of physical servers when said deallocated server is deallocated, with reference to said resource usage of said deallocated server, and
wherein said generating the allocation plan comprises:
generating said allocation plan based on said estimated load, said resource capacity and said resource usage of said deallocated server.

16. The server reassignment support method according to claim 15,
wherein in said determining the deallocated server, said deallocated server is selected one-by-one in ascending order of said resource usage from the virtual servers allocated to said overloaded server until the load of said overloaded server becomes equal to or less than said threshold value.

17. The server reassignment support method according to claim 15,
wherein said determining the deallocated server comprises:
determining said deallocated server so that the load of said overloaded server becomes equal to or less than said threshold value;
selecting a designated deallocation number of virtual server with respect to each of said plurality of physical servers other than said overloaded server; and
adding said selected virtual server further as said deallocated server.

18. The server reassignment support method according to claim 15,
wherein said generating the allocation plan comprises:
calculating remaining amount of said resource capacity of each of said plurality of physical servers based on said resource capacity and said estimated load of said plurality of physical servers; and
determining allocation of said deallocated server with reference to said remaining amount and said resource usage of said deallocated server to generate said allocation plan.

19. The server reassignment support method according to claim 18,
wherein in said determining the allocation of the deallocated server, said allocation of said deallocated server is determined in descending order of said resource usage.

20. The server reassignment support method according claim 14, further comprising: displaying said generated allocation plan by a display device.

21. A server reassignment support program for supporting reassignment of a plurality of virtual servers allocated to a plurality of physical servers, which is recorded on a computer-readable recording medium,
wherein said server reassignment support program causes a computer to perform the processing comprising:
reading an operation data indicating operation status of said plurality of physical servers and said plurality of virtual servers from a storage device;
a step of reading a capacity data indicating resource capacity of each of said plurality of physical servers from a storage device;
extracting an overloaded server from said plurality of physical servers, load of said overloaded server exceeding a threshold value depending on said resource capacity, with reference to said operation data and said capacity data;
estimating a state in which at least part of virtual servers allocated to said overloaded server is deallocated as a deallocated server among said plurality of virtual servers; and
generating an allocation plan for said deallocated server based on said estimated state.
